(19) United States
(12) Patent Application Publication
(10) Pub. No.: US 2009/0105619 A1
(43) Pub. Date: Apr. 23, 2009

(54) Sporting Equipment

(76) Inventor: Jung Bae Kim, Gyeongaangbuk-do (KR)

Correspondence Address: John W Renner;Renner Otto Boisselle & Sklar, 1621 Euclid Avenue 19th Floor, Cleveland, OH, 44115, US

(21) Appl. No.: 12/224,823

(22) PCT Filed: Mar. 5, 2007
(86) PCT No.: PCT/KR2007/001078

§ 371 Date: Sep. 5, 2008

(30) Foreign Application Priority Data
Mar. 7, 2006 (KR) 20-2006-0006109

(51) Int. Cl. A61H 7/00; A61H 1/02

(52) U.S. Cl. 601/84; 601/134; 601/23

(57) ABSTRACT

The present invention provides a sporting apparatus including: a supporter which has a plurality of joint holes and joint grooves formed in the upper surface thereof and stoppers formed on the lower surface thereof; a finger-pressure pad which has joint protrusions formed on the lower surface thereof to be coupled with the joint grooves of the supporter and has a finger-pressure portion formed in the upper surface thereof; pedestals which are provided on the stopper sides of the supporter and has joint holes formed in several faces thereof to adjust the height of the supporter; and knobs coupled with the joint holes of the supporter and the joint holes of the pedestals.

### TECHNICAL FIELD

The present invention relates to a sporting apparatus, and more particularly, to a sporting apparatus which relaxes and trains tense joint portions, such as spines, sternums, calves, and thighs, and muscles around the joint portions to prevent or improve diseases, such as subacromial bursitis and disc diseases, due to wrong postures or over-exertion.

### BACKGROUND ART

In general, the spine is a column of vertebrae and houses cerebrospinal nerves in its spinal canal. Every two adjacent vertebrae are connected through a cartilage bone, resulting in smoother motion. Intervertebral foramina are formed among vertebrae and are passages for the cerebrospinal nerves, which are connected to tissues and organs and transmit nerve energies so as to control the tissues and organs. In this way, the spine serves as a girder of a body supporting the upper part of the body.

Also, the spine serves as joints used for bending and straightening motions to perform various operations with the upper and lower limbs, serves as passages for the spinal cord, which is the central nerve, and the nerve root of peripheral nerves, and serves as the container of calcium which is an inorganic matter needed in the body for survival.

As seen from the side, the spine is normally S-shaped and plays an important role in a dynamic aspect. The spine is composed of seven cervical vertebrae, twelve thoracic vertebrae, five lumbar vertebrae, and a sacrum and coccygeal vertebrae in a sacral portion from the top.

Facilities of civilization has changed the lifestyles of most modern people to sedentary lifestyle. Due to the sedentary lifestyle, it can be easily seen people whose shoulders are imbalanced or who work with the bending back for a long time.

Most modern people sometimes work or drive cars for a long time with the same posture, resulting in abnormalities of joints in spines, necks, shoulders, and breasts. Wrong postures and sitting lives may result in various diseases, such as disc diseases, subacromial bursitis, and arthralgia.

In order to prevent or improve those diseases, modern people use physiotherapy, correction therapy, operations, medicinal therapy, etc. However, since various diseases regarding spines, shoulder joints, and so on result from wrong postures and over-exertion of joints, the effectiveness of an operation or medicinal therapy which cannot remove those causes may not be high.

Physiotherapy or correction therapy is better than an operation in terms of side effects or effects. However, in order to undergo physiotherapy or correction therapy, patients should go to hospitals having a full range of equipment for physiotherapy or correction therapy and pay a lot of money for it.

Further, equipments for physiotherapy or correction therapy or sporting apparatuses having the similar functions to the equipments for physiotherapy or correction therapy are generally machines, expensive, and huge. For this reason, it is difficult for people to use them in a small space such as a home.

### DISCLOSURE OF THE INVENTION

The present invention has been made to solve the above disadvantages and an object of the present invention is to provide a sporting apparatus which can be used to relax and train tense joint portions, such as spines, sternums, calves, and thighs to prevent or improve diseases, such as subacromial bursitis and disc diseases.

Another object of the present invention is to provide a sporting apparatus which can be used to relax and train fourth and fifth cervical vertebrae of a spine for health care.

A further object of the present invention is to provide a sporting apparatus which people can easily use at home.

According to an aspect of the present invention, there is provided a sporting apparatus including: a supporter which has a plurality of joint holes and joint grooves formed in the upper surface thereof and stoppers formed on the lower surface thereof; a finger-pressure pad which has joint protrusions formed on the lower surface thereof to be coupled with the joint grooves of the supporter and has a finger-pressure portion formed in the upper surface thereof; pedestals which are provided on the stopper sides of the supporter and has joint holes formed in several faces thereof to adjust the height of the supporter; and knobs coupled with the joint holes of the supporter and the joint holes of the pedestals.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is an exploded perspective view illustrating a sporting apparatus according to an exemplary embodiment of the present invention;

FIG. 2 is a perspective view illustrating the assembled state of the sporting apparatus shown in FIG. 1;

FIGS. 3A to 3C are views illustrating usage examples where the height of a supporter of the sporting apparatus is adjusted by using pedestals;

FIGS. 4 A to 4D are views illustrating usage examples of the supporting apparatus; and

FIG. 5 is a perspective view illustrating a finger-pressure pad of a sporting apparatus according to another exemplary embodiment.

### BEST MODE

The present invention will now be described more fully hereinafter with reference to the accompanying drawings, in which preferred embodiments of the invention are shown.

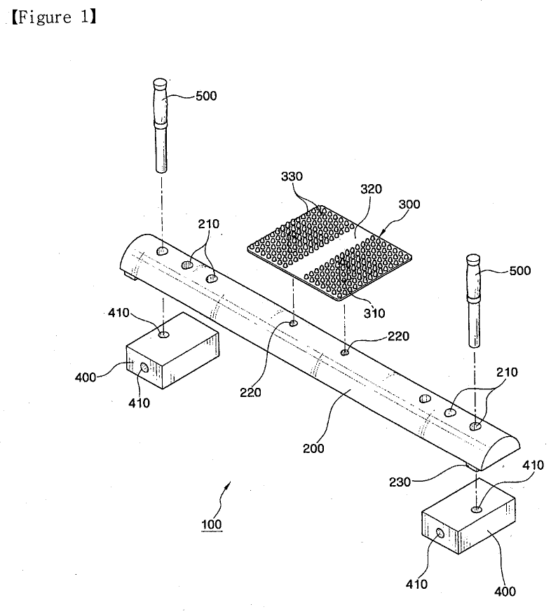

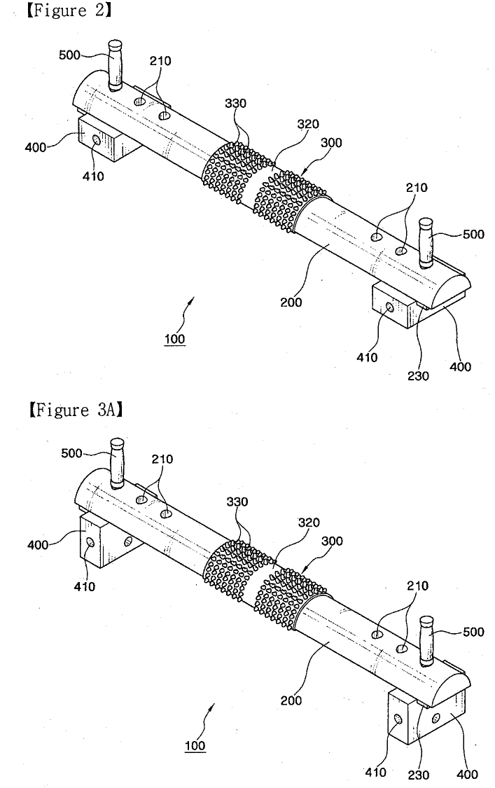

FIG. 1 is an exploded perspective view illustrating a sporting apparatus according to an exemplary embodiment of the present invention and FIG. 2 is a perspective view illustrating the assembled state of the sporting apparatus shown in FIG. 1. Referring to FIGS. 1 and 2, a sporting apparatus 100 according to an exemplary embodiment of the present invention includes a supporter 200, a finger-pressure pad 300, pedestals 400, and knobs 500.

The supporter 200 relaxes or stretches joints of a spine of a user while supporting the back of the user and has substantially a half-column shape. In the upper circumferential surface of the supporter 200, joint holes 210 are formed on both sides and joint grooves 220 are formed in the central portion. Stoppers 230 are formed on both sides of the lower surface of the supporter 200.

The finger-pressure pad 300 serves as a cushion when the user relaxes or stretches the joints of the spine and so on, and performs a finger-pressure treatment. On both sides of the lower surface of the finger-pressure pad 300, joint protrusions 310 are formed to be coupled with the joint grooves 220 of the supporter 200. In the central portion of the upper surface of the finger-pressure pad 300, a space portion 320 is formed. On both sides of the space portion 320, a plurality of finger-pressure protrusions 330 are formed.

The finger-pressure pad 300 may has finger-pressure surfaces 340 as shown in FIG. 5, in addition to the finger-pressure protrusions 330.

The pedestals 400 support the supporter 200, thereby controlling the height of the supporter 200. In order to control the height of the supporter, joint holes 410 are formed in several surfaces of the pedestals 400. The stoppers provided on both sides of the lower surface of the supporter 200 stop the pedestals such that a joint hole 210 of the supporter 200 and a joint hole 410 of a pedestal 400 are positioned along the same line.

The pedestals 400 are coated with a rubber substance or a hot melt adhesive to prevent sliding.

The knobs 500 are coupled with the supporter 200. More specifically, the knobs 500 are inserted into the joint holes 210 formed on both sides of the upper surface of the supporter 200 and the joint holes 410 of the pedestals 400. In this way, the knobs 500 couple the supporter 200 with the pedestals 400.

The working and effect of the present exemplary embodiment will be described with reference to the accompanying drawings in detail.

Referring to FIGS. 2 to 4 A, after a user positions the back of the user on the finger-pressure pad 300 on the supporter 200 while gripping both knobs 500, the user slowly lies on the back along the circumferential surface of the supporter 200 so as to relax or stretch the spine.

In this case, the finger-pressure protrusions 330 of the finger-pressure pad 300 cushion the weight of the user and stimulates and trains muscles around the spine. The space portion 320 of the finger-pressure pad 300 serves as a groove where the spine is positioned and prevents the weight of the user from being concentrated on the spine. Therefore, the user can more comfortably do stretching.

In particular, the fourth and fifth lumbar vertebrae of the spine may easily catch diseases, such as disc diseases. The stretching using the supporter 200 relaxes and trains the fourth and fifth lumbar vertebrae, thereby preventing or improving diseases, such as disc diseases.

When the user lies on the back against the supporter 200 while gripping the knobs 500, the sporting apparatus 100 according to the present exemplary embodiment stretches the back and waist, thereby preventing or improving shoulder diseases, such as subacromial bursitis.

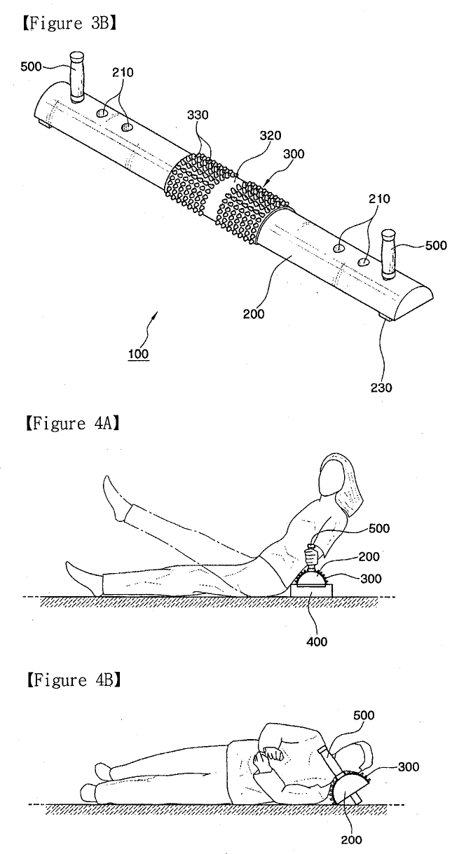

FIGS. 3A and 3B are views illustrating states where the supporter 200 is heightened as compared to FIG. 2, and FIG. 3 C is a view illustrating a state where the pedestals 400 are removed so as to lower the supporter 200 as compared to FIG. 2. As shown in FIGS. 3 A to 3C, the height of the supporter 200 of the sporting apparatus 100 according to the present exemplary embodiment is easily adjusted by changing joint holes 410 of the pedestals 400 into which the knobs 500 are inserted. Therefore, it is possible to supply better stretching effect as the muscles around the spine of the user become stronger.

Further, since the user can do stretching by using the sporting apparatus 100 while moving the upper part of the body up and down, the user can stretch and train the spine from the cervical vertebrae to the coccygeal vertebrae in addition to the lumbar vertebrae, thereby training the whole spine.

Further, the user can do stretching by using the sporting apparatus 100 while repeatedly moving up and down the lower part of the body, thereby stretching and training the lumbar vertebrae, sacrum, and coccygeal vertebrae.

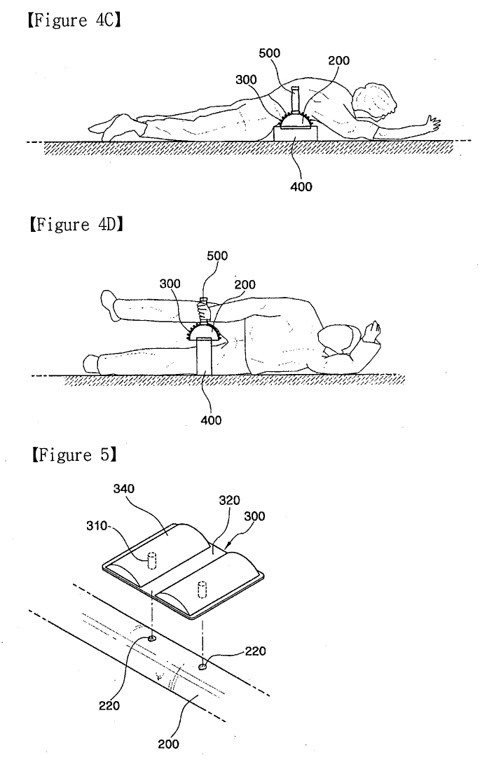

FIG. 4B is a view illustrating an example where neck stretching is done by using the sporting apparatus according to the present exemplary embodiment. As shown in FIG. 4B, the pedestals 200 are removed from the sporting apparatus and the supporter 200 is inclined at about 40°. In this state, the sporting apparatus is used as a wooden pillow. Therefore, when the user lies on user's side, the user can stretch and train muscles around the upper cervical vertebrae and ears by the weight of the head.

FIG. 4C is a view illustrating an example where abdomen stretching is done by using the sporting apparatus according to the present exemplary embodiment. As shown in FIG. 4C, when the user lies on user's face such that the abdomen is positioned on the supporter 200 and moves back and forth and right and left, the internal organs of the abdomen are stimulated, thereby speeding up metabolism.

FIG. 4D is a view illustrating an example where thigh stretching is done by using the sporting apparatus according to the present exemplary embodiment. As shown in FIG. 4D, the user lays a thigh on the sporting apparatus and then sets legs apart or moves back and forth, thereby doing stretching.

The foregoing exemplary embodiments and advantages are merely exemplary and are not to be construed as limiting the present invention. Although now exemplified, the finger-pressure pad may be used to give finger-pressure to the soles of feet. Further, the sporting apparatus may be used to stretch and train various parts of a body, such as calves, in addition to thighs.

### INDUSTRIAL APPLICABILITY

As described above, the sporting apparatus according to the exemplary embodiments of the present invention is used to relax and train a tense spine so as to make a waist strong and prevent or improve diseases, such as disc diseases.

Further, the sporting apparatus according to the exemplary embodiments of the present invention can be used to relax and train shoulder muscles so as to prevent or improve diseases, such as subacromial bursitis. Further, the sporting apparatus can be used for abdomen finger-pressure and stretching so as to stimulate organs and muscles, thereby speeding up metabolism.

Furthermore, the sporting apparatus according to the exemplary embodiments of the present invention can be used to relax and train other parts of a body, such as thighs and calves. Therefore, the sporting apparatus is very useful. In addition, since the sporting apparatus has a simple structure, the manufacturing cost of the sporting apparatus is reduced, and the sporting apparatus can be easily used and kept in a small space.

What is claimed is:

1. A sporting apparatus comprising:
a supporter 200 which has a plurality of joint holes 210 and joint grooves 220 formed in the upper surface thereof and stoppers 230 formed on the lower surface thereof;
a finger-pressure pad 300 which has joint protrusions 310 formed on the lower surface thereof to be coupled with the joint grooves 220 of the supporter 200 and has a finger-pressure portion formed in the upper surface thereof;
pedestals 400 which are provided on the stopper sides of the supporter 200 and has joint holes 410 formed in several faces thereof to adjust the height of the supporter 200; and
knobs 500 coupled with the joint holes 210 of the supporter 200 and the joint holes 410 of the pedestals 400.

2. The sporting apparatus as claimed in claim 1, wherein the finger-pressure
portion of the finger-pressure pad 300 has a space portion 320 formed in the central portion thereof and a plurality of finger-pressure protrusions 330 formed on both sides of the space portion 320.

3. The sporting apparatus as claimed in claim 1, wherein the finger-pressure portion of the finger-pressure pad 300 has finger-pressure surfaces 340 formed in an arc type on both sides of the upper surface thereof and a space portion 320 formed in the central portion thereof.
